(19) United States
(12) Patent Application Publication
(10) Pub. No.: US 2026/0205272 A1
(43) Pub. Date: Jul. 16, 2026

(54) Access Control to a Motor Vehicle

(71) Applicant: Bayerische Motoren Werke Aktiengesellschaft, Muenchen (DE)

(72) Inventors: Marco HIPPLER, Muenchen (DE); Thorsten KNOTT, Tuntenhausen (DE); Lukas REINHART, Freising (DE)

(21) Appl. No.: 19/448,459

(22) Filed: Jan. 14, 2026

(30) Foreign Application Priority Data
Jan. 15, 2025 (DE) 10 2025 101 352.7

(51) Int. Cl. H04L 9/08; H04L 9/00

(52) U.S. Cl. CPC H04L 9/0825; H04L 9/006

(57) ABSTRACT

A digital key is provided for securing use of a motor vehicle. A public key of a receiver and a first secret is transmitted from the receiver to a key service. A key service compares first secret with a second secret previously received from a sender for the digital key. The result of the comparison is assigned to the public key by the key service. The public key and an attestation of the digital key is transmitted from the receiver to the key service. The key service determines that the public key last received from the receiver was assigned a positive comparison result. The attestation is transmitted from the key service to the motor vehicle.

### CROSS REFERENCE TO RELATED APPLICATION

This application claims priority under 35 U.S.C. §119 from German Patent Application No. DE 10 2025 101 352.7, filed January 15, 2025, the entire disclosure of which is herein expressly incorporated by reference.

### BACKGROUND AND SUMMARY

The present invention relates to access control to a motor vehicle. In particular, the invention relates to the creation of a digital key for the access control to the motor vehicle.

A motor vehicle can be secured by means of a digital vehicle key. For this purpose, digital keys in the form of predetermined cryptographic constructs are respectively deposited on the motor vehicle and on a mobile device. For the access to the motor vehicle, the device and the motor vehicle can communicate wirelessly with one another and carry out a predetermined cryptographic method using the key. Such a technology is known as a digital car key, which is specified by the “Car Connectivity Consortium”.

Different roles can be predetermined with respect to the concept of digital vehicle keys, to which different authorizations are assigned, for example an “owner” and a “friend”. An owner can create a new digital vehicle key, to which predetermined rights are assigned, for a friend. A method which includes the at least one owner, the friend, and a key management function is defined for the creation and storage of the new key at the required points.

In one method step, an invitation to create a key can be sent from the owner to the friend. The communication can be secured by means of a second factor, which is transmitted to the friend on a different physical channel than the invitation. It has been shown that nonetheless the risk of a Janus attack (also: “man-in-the-middle attack”) can exist, in which

messages are captured by a third party and input again to ultimately unlawfully obtain a key for the motor vehicle.

One object underlying the present invention is providing a method using which the creation process of a digital key, which is provided by a sender to a receiver, can be made more secure. The method achieves this object by means of one or more features of at least one embodiment disclosed herein.

The present invention proceeds on the basis of a method for creating a digital vehicle key in which a first entity grants a usage right to a second entity. In the present case, the first entity is called “sender” and the second entity is called “receiver”.

It is proposed, in a method for providing such a key by way of a sender to a receiver, a first and a second message of the receiver each be assigned to one another at a key service on the basis of a respective public key of the receiver which is also sent. The first message comprises a secret which was previously transmitted from the sender to the receiver and the key service, and the second message comprises an attestation. The first message can be designated as “sendPin()”, the second message as “trackKey()”. The attestation can then be signed by the key service to make the created digital key usable.

The present invention represents an advantageous modification of a procedure proposed in the Digital Key Standard of the Car Connectivity Consortium. In that respect, reference is made in particular to chapter 11-5 of Version 4 of the Digital Key Standard.

The sender typically has a digital vehicle key with which he or she himself or herself has the power of disposition over a motor vehicle, and which enables him or her to validate a new vehicle key. Sender and receiver have devices using which digital vehicle keys can be stored and managed (as cryptographic constructs). These devices can each in particular comprise a mobile device such as a smart phone, a smartwatch, a smart band, a tablet computer, a laptop computer, or a dedicated device (“fob”).

The concept of digital vehicle key is preferably implemented as an asymmetrical cryptographic encryption method. A key pair, which comprises a public and a private key, is assigned in each case here to the sender and the receiver. An encryption which was carried out using one of the keys can only be reversed using the other. The private key is only to be known to its owner, while the public key can be published practically arbitrarily.

If a person uses a device on which a private key is stored in order to access a stored digital vehicle key or a private key or to use a cryptographic method on the basis of such a vehicle key, it is typically necessary for the person to first authenticate themselves to the mobile device. For this purpose, the person can present a biometric feature or input a predetermined secret (password, PIN). The authentication can be checked by an operating system of the device.

In simplified terms, reference is made herein to the fact that the sender or the receiver performs certain actions or executes certain functions, even if, strictly speaking, an action of a person who operates a corresponding device is required. A communication of a sender device or a receiver device with another device preferably takes place wirelessly, for which in particular a mobile wireless network or a direct transmission by means of radio waves can be used.

If an environment according to Release 3 of the CCC standard is presumed, the sender can comprise an owner and the receiver can comprise a friend, wherein both are ultimately represented by natural people. In an environment according to Release 4 of the CCC standard, sender and receiver can each occupy one of multiple predetermined roles which permits a corresponding granting or forwarding of rights. In addition, a sender or a receiver can also be represented by an automatic system; in this case, for example, reference can be made to a Server Based Owner Device (SBOD) or a Server Based Friend Device (SBFD).

A service, such as a key service, an exchange service, or a tracking service, is preferably implemented by a computer or a server. The service can be located in a cloud and can be reached via a communication network. The communication network can be embodied as partially wireless and in particular can comprise a mobile wireless network. Services can also be networked with one another, alternatively in a wireless or wired manner.

More precisely, a method for providing a described digital vehicle key by way of a sender to a receiver comprises steps of transmitting, from the receiver to a key service, a public key of the receiver and a secret; comparing, by the key service, the secret received from the receiver with a secret previously received from the sender with respect to the same key; assigning, by the key service, a comparison result to the received public key of the receiver; transmitting, from the receiver to the key service, the public key of the receiver and an attestation of a key created by the receiver; determining, by the key service, that the public key last received from the receiver is assigned a positive comparison result; and signing of the attestation by the key service.

The first message transmitted by the receiver to the key service, which contains the secret, and the second message, which comprises the attestation, can thus be assigned to one another in an improved manner. Even if a third party were to guess a parameter of the first message, they cannot create the second message so that the key service assists the third party in obtaining a functioning digital key for the motor vehicle.

The attestation is preferably transmitted to the motor vehicle and stored therein. The attestation typically has to be transmitted to the motor vehicle before a first use of the motor vehicle on the basis of the key. If the key is then shown to the motor vehicle, the use of the motor vehicle can be authorized. The attestation can be transmitted directly from the key service to the motor vehicle. If this communication should not be possible, for example because

a wireless transmission link is disturbed, the attestation can also be transmitted from the key service to the receiver and can be shown thereby to the motor vehicle.

The sender can determine a description of the key and transmit it to the receiver; and the receiver can create the key on the basis of the description. The description can comprise properties and in particular rights of the key and can be used as a creation request for the key. The sender can transmit an invitation to create the key to the receiver, wherein the invitation comprises the description.

The sender can transmit an identification of the description to the key service together with the secret. The receiver can transmit an identification of the description together with the secret to the key service. The key service preferably compares secrets with one another which are assigned to corresponding identifications received from the sender or from the receiver.

The identification can also be called sharingId. The identification can comprise a hash relating to the description. The hash can be created according to a predetermined general method or as a cryptographic hash with respect to a predetermined key.

The receiver can transmit the created key to the sender; the sender can sign the created key; and the sender can transmit the signed key to the receiver. Only when the key is signed by the sender can it be further processed or ultimately be used successfully for controlling the motor vehicle.

The sender can initially determine the secret and transmit it to the key service and to the receiver. The invitation and the secret are preferably transmitted in different ways from the sender to the receiver. For this purpose, different transmission paths or different transmission methods can be selected. For example, the invitation can be transmitted directly or via an interconnected post office box via a data network, while the secret can be transmitted

via post, orally, or via SMS to the receiver. On the part of the receiver, a person can be prompted to manually input the received secret again so that it can be processed by the receiver device.

The receiver can transmit the attestation to the key service after the key service has transmitted a notification of a positive comparison result to the receiver. The comparison result can only be positive if the two secrets correspond with one another. If they do not correspond or if two secrets which are assigned to one another cannot be determined, the comparison result is negative. A comparison result which is not present is preferably considered to be a negative result.

In at least one embodiment, the method essentially comprises the following steps:

determining, by the sender, a secret and a description of the key to be created;

transmitting, from the sender to a key service, the secret and an identification of the description;

assigning, by the key service, the secret to the identification;

transmitting, from the sender to the receiver, the secret and the description of the key to be created;

creating, by the receiver, the digital key on the basis of the description;

transmitting, from the receiver to the key service, a public key of the receiver, a secret, and an identification of the description;

comparing, by the key service, the secret received from the receiver with a secret which is assigned to the identification received from the receiver; and assigning a comparison result to the public key of the receiver;

transmitting, from the receiver to the key service, the public key of the receiver and an attestation of the created key;

determining, by the key service, that a positive comparison result is assigned to the public key last received from the receiver; and

transmitting the attestation from the key service to the motor vehicle.

In the described scenario, in which a receiver is to be provided by a sender with a digital key which secures the use of a predetermined motor vehicle, a further aspect of the present invention relates to a key service. The key service is configured to receive, from a receiver, a public key of the receiver and a secret; to compare the secret received from the receiver with a secret previously received from a sender with respect to the same key; to assign a comparison result to the received public key of the receiver; to receive, from the receiver, the public key of the receiver and an attestation of a key created by the receiver; to determine that the public key last received from the receiver is assigned a positive comparison result; and to sign the attestation.

The key service is preferably configured to at least partially carry out a method described herein. For this purpose, the key service can comprise an in particular electronically embodied processing unit, which comprises, for example, an integrated circuit, a programmable logic device, or a programmable microcomputer. The method can be implemented in the form of a configuration or as a computer program product having program code means for the processing unit. The configuration or the computer program product can be stored on a computer-readable data carrier. Features or advantages of the method can be transferred to the device or vice versa.

The key service is preferably furthermore configured to transmit or forward the signed attestation to the motor vehicle and/or to the receiver. The receiver can show the key to the motor vehicle and thus obtain access to a predetermined vehicle function. The vehicle function can in particular comprise opening a central locking system or starting a drive motor.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 illustrates a system; and

FIG. 2 illustrates a flow chart of a method.

### DETAILED DESCRIPTION OF THE DRAWINGS

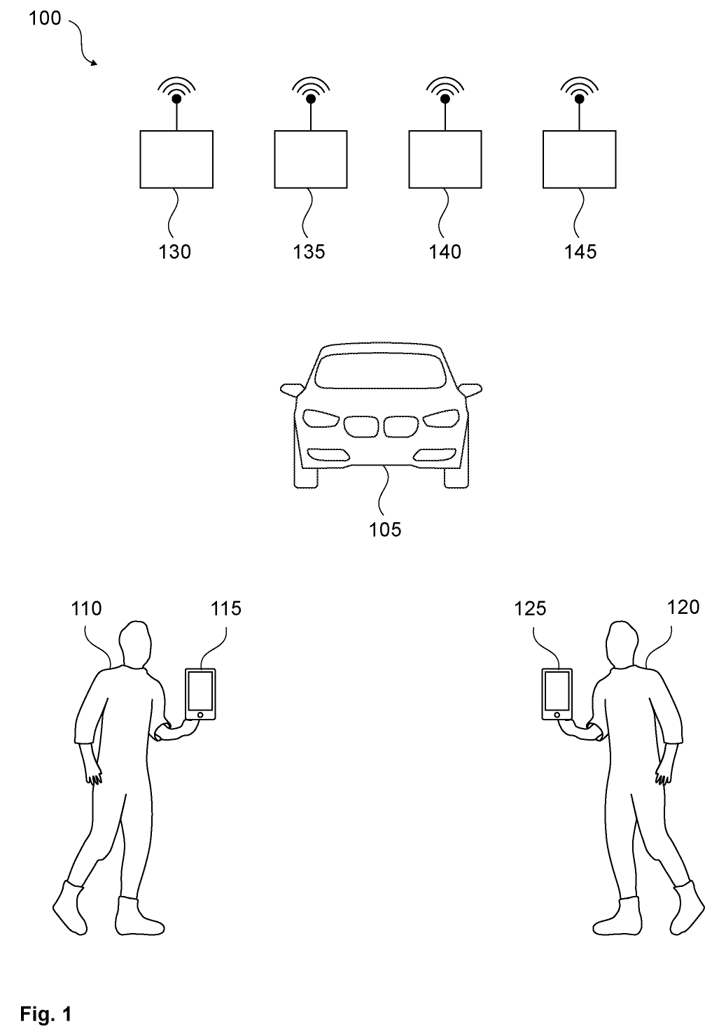

FIG. 1 shows a system 100 for controlling an access to a motor vehicle 105. The system 100 is preferably configured to work according to the specifications of the Digital Car Key (CCC). In this respect, a large number of methods which can relate to different aspects or functions of a Digital Car Key can be executed. One method described herein relates to creating a digital key from a sender 110 of the motor vehicle 105 to a receiver 115, storing the key, and providing matching cryptographic information to the motor vehicle 105.

The sender 110 uses a sender device 120 and the receiver 115 uses a receiver device 125. The devices 120, 125 are assigned to people 110, 115 here and can each be implemented, for example, in the form of smart phones. Reference is made for the sake of better comprehension hereinafter to the sender 110 or the receiver 115 performing an action even if on the technical level a sender device 120 or a receiver device 125 is used for this purpose. An intervention or an action specifically by a person 110, 115 is specifically indicated hereinafter. The devices 120, 125 can be comprised by the system 100, but not the people 110, 115.

The system 100 can comprise an optional exchange service 130 (Relay Server), a key service 135 (OEM Server), an optional transmission service 140 (Routing Server), and a tracking service 145 (Friend Device Server). The exchange service 130 and/or the tracking surface 145 can be omitted in some embodiments. The transmission service 140 is indicated

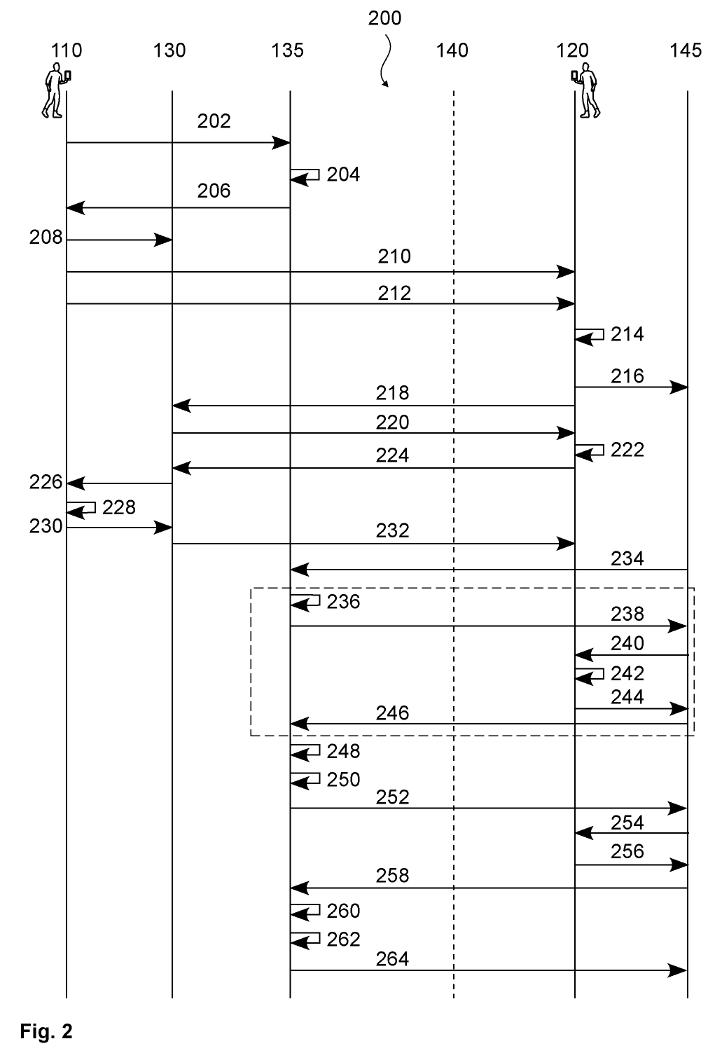

for better comparability with known methods; it does not play a role in the method of FIG. 2.

The key service 135 is configured to manage keys for the motor vehicle 105. In particular, the key service 135 can, as a central instance, cryptographically sign keys in order to confer validity on them. Optionally, the key service 135 can also be connected to the motor vehicle 105 or manage data related to the motor vehicle 105, for example with respect to a person who is the driver or passenger of the motor vehicle 105.

The exchange service 130 is configured to accept items of information and make them available under an access address. Different stored items of information are separated from one another, so that each access address only leads to precisely the stored items of information, and items of information with respect to different keys are not mixed. The transmission service 140 can essentially perform forwarding of data traffic, for example like a router or a proxy server. However, data may not be forwarded, but only stored therein, so that they have to be retrieved by a receiver.

The tracking service 145 is configured to track which digital keys are active for the motor vehicle 105. A history can be created for each generated key, which can indicate in particular from when to when the key is or was valid or to whom the key was issued and when. It can be ensured technically that a created key can only be used for the use of the motor vehicle 105 if the key is tracked at the tracking service 140.

FIG. 2 shows a flow chart of a method 200 for creating a digital key for a receiver 115 by way of a sender 110. A time runs from top to bottom. Messages which are exchanged between participating parties or actions which are carried out by participating parties are shown in the horizontal direction.

The method 200 can be a modification of a known method for forwarding a digital key. The method shown can differ in particular in steps 232, 248, 256, 258, and 260

from a known method. For a known method, reference is made to chapters 11.5 and 17.7 of Version 4 of the CCC standard “Digital Car Key”.

In a step 202, the sender 110 can store items of information with respect to the key to be created and a secret at the key service 135. The transmitted items of information can comprise an identification of a description of the key to be created. The identification can in particular comprise a hash relating to the description and is sometimes also referred to as sharingId. The secret is preferably determined by the sender 110, for example as a random code, and can in particular comprise a sequence of numbers or characters.

In a step 204, the secret can be deposited at the key service 135. The identification can likewise be deposited, wherein an assignment can take place so that a deposited secret can be found on the basis of an identification.

In a step 206, the key service 135 can confirm the deposit to the sender 110. This sender can, in a step 208, create a mailbox at the exchange service 130. A request to create a key to the receiver 120 can be stored in the mailbox. The request can comprise the description of the key to be created.

In a step 210, an invitation for access to the exchange service 130 can be transmitted from the sender 110 to the receiver 120. The invitation comprises an identification of the created mailbox. In a step 212, the previously created secret can be transmitted from the sender 110 to the receiver 120. Different communication channels can be used here for the invitation and the secret, for example by means of a messaging service such as iMessage and by means of SMS. The received secret can be output at the receiver device 115 to the receiver 120.

In a step 214, an input can be detected at the receiver device 125, which can follow a request for input of the secret. At this point, the person of the receiver 120 can act, for example in that they read the received secret at the receiver device 125 and input it manually

into their receiver device 125. For the present method, the input is not relevant, but rather the detection of the input.

In a step 216, the secret and the identification of the description can be transmitted from the receiver 120 to the tracking service 145. In a step 218, the receiver 120 can request the content of the mailbox at the exchange service 130. The exchange service 130 can thereupon, in a step 220, provide the stored description in the form of a request for key creation to the receiver 120.

The receiver 120 can create the key on the basis of the description in a step 222. For this purpose, he or she can use his or her own private key and the created key is to have the properties and authorizations which are indicated in the description.

In a step 224, the receiver 120 can transmit the key for signing to the exchange service 130; and the exchange service 130 can forward the request, in a step 226, to the sender 110. The sender 110 can sign the key, in a step 228, and transmit the signed key, in a step 230, to the exchange service 130, which can forward it, in a step 232, to the receiver 130. This can take place in the form of a request to import the key (import request).

In a step 234, the tracking service 234 can transmit the secret together with a public key of the receiver 120 to the key service 135. Preferably, the identification is additionally also transmitted. The secret and/or the identification can be encrypted using a public key of the key service 135 and/or signed using a private key of the receiver 120.

Optionally, it can be determined in a step 236 on the part of the key service 135 that the secret received from the receiver 120 (or from the tracking service 145) is not identical with the secret received from the sender 110 (or the exchange service 130). The key service 135 can determine the secret received from the sender 110 on the basis of the identification received from the receiver 120 (cf. step 204). In this case, the key service 135, in a step 238, can transmit a message with respect to the incorrect secret to the tracking service 145, which

the tracking service 145 can forward, in a step 240, to the receiver 120. In a step 242, a new attempt can be undertaken to read out the secret received at the receiver 120 from the sender 110 and input it into the receiver device 125 or detect a new input of the secret. The newly detected secret can be transmitted, in a step 244, to the tracking service 145 and this can transmit the newly detected secret, in a step 246, to the key service 135. Steps 236 to 246 can optionally be run through again. A number of runs is typically restricted, for example to a total of three inputs of the secret. If the secrets should then still not correspond, the method 200 can end unsuccessfully.

In a step 248, it can be determined that the secrets of the sender 110 and the receiver 120 correspond. A procedure as described above with respect to step 236 can be used for the check. In a step 250, the comparison result can be stored. It is proposed that the comparison result be assigned to the received public key of the receiver 120 so that the comparison result can be found later with respect to the public key. If the secrets should be identical with one another, the comparison result is positive; if they are not identical, it is negative. If one of the secrets should not be stored at the key service 135, it can be considered to be negative.

In a step 252, a message about the correct secret can be transmitted to the tracking service 145. In a step 254, this message can be forwarded from the tracking service 145 to the receiver 120.

In a step 156, the receiver 120 can transmit a request for tracking the generated key (trackKey) to the tracking service 145. An attestation, which comprises cryptographically relevant items of information that the motor vehicle 105 has to have to check the generated key for correctness, is appended to the request. It is furthermore proposed that the public key of the receiver 120 be appended to the request. The request can be forwarded, in a step 156, from the tracking service 145 to the key service 135.

In a step 260, the key service 135 can obtain the comparison result of step 250. For this purpose, it is proposed that a stored comparison result with respect to the most recently received public key of the receiver 110 be found. If the comparison result is positive, the key service 135 can sign the attestation in a step 262. The signed attestation can be transmitted in a step 264 to the tracking service 145. The attestation can then be forwarded to the receiver 120 and/or the motor vehicle 105.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMERALS

100 system

105 motor vehicle

110 sender

115 sender device

120 receiver

125 receiver device

130 exchange service

135 key service

140 transmission service

145 tracking service

200 method

202 store description and secret

204 deposit secret

206 confirm deposit

208 create mailbox

210 transmit invitation

212 transmit secret

214 detect input of the secret

216 transmit identification

218 request content of the mailbox

220 provide content of the mailbox

222 create key

224 request signing of the key

226 request signing of the key

228 sign key

230 request to import the key

232 request to import the key

234 send secret

236 secret of the sender not identical to secret of the receiver

238 inform about incorrect secret

240 inform about incorrect secret

242 input secret again

244 transmit new secret

246 transmit new secret

248 secret of the sender identical with secret of the receiver

250 store comparison result and public key

252 inform about correct secret

254 inform about correct secret

256 request to track the key

258 request to track the key

260 obtain comparison result

262 sign attestation

264 forward attestation

What is claimed is:

1. A method for providing a digital key that secures a use of a motor vehicle, comprising:
transmitting a public key of a receiver and a first secret from the receiver to a key service;
comparing, by the key service, the first secret with a second secret previously received from a sender for the digital key;
assigning a result of the comparison to the public key by the key service;
transmitting, from the receiver to the key service, the public key and an attestation of the digital key;
determining, by the key service, that the public key last received from the receiver was assigned a positive comparison result; and
transmitting the attestation from the key service to the motor vehicle.

2. The method of claim 1, further comprising:
showing the digital key and the attestation to the motor vehicle; and
authorizing a use of the motor vehicle.

3. The method of claim 2, wherein the attestation has to be shown before a first use of the motor vehicle based on the digital key.

4. The method of claim 1, wherein the sender determines a description of the digital key and transmits the description to the receiver, and wherein the receiver creates the digital key based on the description.

5. The method of claim 4, further comprising:
transmitting, by the sender, a second identification of the description to the key service together with the second secret;
transmitting, by the receiver, a first identification of the description to the key service together with the first secret; and
comparing, by the key service, the first secret with the second secret correspondingly assigned to the first and second identifications.

6. The method of claim 5, wherein the identification comprises a hash relating to the description.

7. The method of claim 1, wherein the receiver transmits the digital key to the sender, wherein the sender signs the digital key, and wherein the sender transmits the signed key to the receiver.

8. The method of claim 1, wherein the sender determines the second secret, and wherein the sender transmits the second secret to the key service and to the receiver.

9. The method of claim 1, wherein the receiver transmits the attestation to the key service after the key service has transmitted a notification of a positive comparison result to the receiver.

10. A key service, comprising:
a processing unit configured by instructions stored on a non-transitory computer readable medium to:
receive, from a receiver, a public key of the receiver and a first secret;
compare the first secret to a second secret previously received from a sender for a digital key;
assign a result of the comparison to the public key;
receive, from the receiver, the public key and an attestation of the digital key;
determine that a positive comparison result was assigned to the public key last received from the receiver; and
transmit the attestation from the key service to the motor vehicle.
